(19) United States
(12) Patent Application Publication
(10) Pub. No.: US 2025/0332780 A1
(43) Pub. Date: Oct. 30, 2025

(54) ADDITIVE MANUFACTURING PROCESS FOR HIGH PERFORMANCE COMPOSITE PRESSURE VESSELS AND STRUCTURES

(71) Applicant: Infinite Composites Inc., Tulsa, OK (US)

(72) Inventors: R. Matt Villarreal, Bixby, OK (US); Tarell D. Nunley, Glenpool, OK (US); Connor Copeland, Broken Arrow, OK (US)

(21) Appl. No.: 18/707,782

(22) PCT Filed: Nov. 9, 2022
(86) PCT No.: PCT/US2022/049405

§ 371 Date: May 6, 2024

Related U.S. Application Data
(60) Provisional application No. 63/277,235, filed on Nov. 9, 2021.

(51) Int. Cl. B29C 53/82; B29C 33/52; B29C 70/30; B29L 31/00; B33Y 10/00; B33Y 40/20; B33Y 50/02; B33Y 80/00

(52) U.S. Cl. CPC B29C 53/822; B29C 33/52; B29C 70/30; B29L 2031/7156; B29L 2031/757; B33Y 10/00; B33Y 40/20; B33Y 50/02; B33Y 80/00

(57) ABSTRACT

Systems and methods of this disclosure optimize the manufacturing of composite pressure vessels and structures by streamlining the fabrication of tooling and internal structures through use of additive manufacturing processes such as vat polymerization, material or binder jetting, material extrusion, and powder bed fusion to improve quality, scalability, extensibility, and cost effectiveness. In embodiments, a computer readable medium storing computer readable instructions which, when acted upon by a 3D printer, cause the 3D printer to print a mandrel (10) of a composite pressure vessel, the mandrel having a predetermined size, shape, and internal volume (10b) and including at least one end (13) having an opening (17) to the internal volume.

### BACKGROUND

This disclosure is in the field of composite pressure vessels, more particularly, to methods of forming the pressure vessel using gas-impermeable composite materials which include carbon fibers and are intended for use in high and low pressure applications.

Dissolvable tooling produced with casting or subtractive processes have been used for decades to produce composite pressure vessels and structures. Currently, polyvinyl alcohol (“PVA”) and other similar water soluble tooling is utilized. A typical block is fabricated and then machined to the final dimensions. This method is widely used but costly and time consuming. Other methods consist of lost mold casting, where wax or other materials are melted or burned out.

All of the casting methods require a high upfront cost for investment in tooling. Each tool is specific to one geometry, typically one application use. The types of complex geometries that can be formed using these methods are limited.

### SUMMARY

Embodiments of a composite pressure vessel of this disclosure do not make use of casting or subtractive processes but rather include a 3D printed mandrel. The mandrel may be 3D printed using additive manufacturing processes such as vat polymerization, material or binder jetting, material extrusion, and powder bed fusion.

In embodiments, a non-transitory or computer readable medium storing computer readable instructions which, when acted upon by a 3D printer, cause the 3D printer to print a mandrel of a composite pressure vessel, the mandrel having a predetermined size, shape, and internal volume and including at least one end having an opening to an internal volume of the mandrel. The computer readable instructions may further cause the 3D printer to print one or more fluid management devices integral to and contained by the mandrel. The computer readable instructions can be in a slicing file. A digital representation of the 3D printed mandrel may be stored and displayed.

The mandrel may be 3D printed as a single unit or its component parts may be printed. For example, a first end section, a second end section, and a middle section of the mandrel may be individually printed and then assembled. The middle section or body of the mandrel may be a single printed part or two or more printed parts joined together. One or more of the fluid management devices may be printed as part of the first end, the second end, or the middle section (or some combination thereof). The first and second ends may be domed and the middle section cylindrical. One or both ends may include a boss that provides the opening to the interior volume. The boss may be 3D printed. A fitting or valve may be connected to the boss or the end. The fitting or valve may be 3D printed.

The fluid management device may be a baffle. The baffle may be arranged coaxial a longitudinal centerline of the mandrel. The baffle may extend in a radial direction relative to the longitudinal centerline of the mandrel. The baffle may include a plurality of through holes.

In some embodiments, the fluid management device is a cylinder arranged coaxial to a longitudinal centerline of the mandrel. The cylinder may include a plurality of though holes. The cylinder may be connected to the boss.

The fluid management device can be a wall that divides the internal volume into at least two chambers. The chambers may be in fluid communication with one another. In other embodiments, the fluid management device may be a channel such as, but not limited to, a cooling channel. In other embodiments, the fluid management device is a diaphragm.

Embodiments of a method of this disclosure for producing a composite pressure vessel include 3D printing a mandrel, the mandrel having a predetermined size, shape, and internal volume, the mandrel including at least one end having an opening to the internal volume; after the 3D printing, smoothing surface imperfections, filling surface voids, or smoothing surface imperfections and filling surface voids; after the smoothing or filing or smoothing and filling, assembling at least one fitting to the mandrel; after the assembling, applying an impermeable film to the at least one fitting and the mandrel; after the applying, encapsulating the impermeable film by applying at preprogramed angles a carbon fiber roving and resin to the mandrel; and after the encapsulating, curing the composite pressure vessel.

The smoothing and filling is done because of layer lines on the outside surface of the printed mandrel. The mandrel could be used as-is is but might affect performance by transferring these lines to the fiber shell. The smoothing and filing is done using the same material as that used for printing the mandrel. It too is an additive process.

In some embodiments, the method includes 3D printing a fluid management device integral to and contained by the mandrel. The mandrel may include at least two 3D printed parts that are then assembled together. The fluid management device may be printed as a component of one or both of the two 3D printed mandrel parts. Where the mandrel is soluble—because a liner-free composite pressure vessel is desired—the method further comprises, after the curing, flushing the pressure vessel with water to dissolve or remove the mandrel.

### BRIEF DESCRIPTION OF DRAWINGS

FIG. 1 is a process flow for mandrel parts made according to this disclosure that are dissolved after the composite wrap is cured.

FIG. 2 is a process flow for printed mandrel parts made according to this disclosure that remain inside the tank after production.

FIG. 3 is an embodiment of a printed mandrel part (end cap) with an integrated fluid management device (perforated holes). The spokes provide strength to the part during winding. Where printed as soluble, the device can be removed from the final composite pressure vessel.

FIG. 4 is an embodiment of a printed mandrel part (middle section or main body) with integrated slosh baffles (radial structures with perforations). The slosh baffles provide strength and, where printed as soluble, can be removed from the final compositive pressure vessel.

FIG. 5 is a cutaway of an embodiment of a finished tank of this disclosure with an enclosed tank/fluid volume inside produced by way of additive manufacturing. For example, the tank may be 3D printed and then used as a substructure for 3D printing a soluble mandrel. When the mandrel is removed by flushing, an annular space is left between the tank and the composite fiber shell of the pressure vessel.

FIG. 6 is partial cutaway view of an inside surface of another embodiment of the printed mandrel. The inside surface may include an iso-grid, that is, a hexagonal- or triangular shaped lattice structure facing normal to the surface. The iso-grid provides strength that helps take the load of fiber winding and permits a thinner printed structure. The mandrel may be printed as a single part or as a plurality of parts joined together in this embodiment as well as in other embodiments.

FIG. 7 is an enlarged view of the iso-grid of FIG. 6. The printed mandrel may include an annular snap fit arrangement like that shown to assemble sections of the printed mandrel. Other means of connecting printed end caps to the body or connection sections of the body can include a tongue-and-groove and cone-and-cup arrangement.

### ELEMENTS AND ELEMENT NUMBERING

10 3D printed mandrel
10a Outside surface of mandrel
10b Internal volume
10c Inside surface of mandrel
11 Middle section or body
11a First middle section
11b Second middle section
13 End section or cap
13a First end section or section or cap
13b Second end cap
15 Fitting or boss
17 Passageway or opening
19 Impermeable film
21 Carbon fiber roving and resin
21a Composite fiber shell of pressure vessel
23 Spoke
25 Cylindrical shaped fluid management device
27 Through hole
29 Central longitudinal axis of mandrel (and pressure vessel)
31 Baffle
33 Rib
35 Internal tank
37 Annular space
41 Chamber
43 Iso-grid
47 Snap fit
49 Channel
50 Final pressure vessel

### DETAILED DESCRIPTION

Systems and methods of this disclosure optimize the manufacturing of composite pressure vessels and structures by streamlining the fabrication of tooling and internal structures through use of additive manufacturing processes for example vat polymerization, material or binder jetting, material extrusion, and powder bed fusion to improve quality, scalability, extensibility, and cost effectiveness.

The additive manufacturing process may be vat polymerization to produce the mandrel tool in a vat containing liquid photopolymer resin. An ultraviolet (“UV”) light may be used to cure or harden the resin where required, the build platform being indexed after each new layer is cured to receive the next layer. In other embodiments, the additive manufacturing process is binder jetting in which the printhead selectively deposits a liquid binding agent onto a thin layer of metal, sand, ceramic, or composite powder particles to build the mandrel. The process is repeated layer by layer until the mandrel is printed. In yet other embodiments, the additive manufacturing process may be material extrusion in which a continuous filament of thermoplastic or composite material in the form of a plastic filament is fed through a heated nozzle and then deposited onto the build platform to form the mandrel layer by layer. Or, the additive manufacturing media may be powder or pellet bed fusion where a hopper provides the media material for the mandrel and each layer of the mandrel is sequentially bonded on top of the preceding adjacent layer. The mandrel can be produced as a singular structure or as individual components which are joined together to form an assembly. The joining can be done by way of a glue made of the same material used to print the mandrel, a welding process (heat and melt), or an annular snap fit (e.g. male and female tab). The mandrel can also include a mix of soluble and insoluble mandrel components which is useful for producing integral features in the structure such as segmented chambers, anti-slosh baffles, diaphragms, and other fluid management devices.

The pressure vessels of this disclosure may be of a liner-less or a liner-free pressure vessel that is, not having any metallic or plastic liner inward of the innermost layer of composite material of the vessel in its final manufactured configuration, the mandrel having been washed away or dissolved, the composite shell formed about the mandrel remaining. When in an intended use, because there is no inner liner, there is no barrier between the gas, liquid, or powder being contained by the vessel and other than the innermost facing surface of the shell. The mandrel tool may be removed by submerging the vessel in, or flushing it out, with water or other suitable solvent (which may be agitated).

In other embodiments, a non-soluble metallic or polymeric mandrel may be used, remaining with the vessel and forming a liner or internal structure. However, removing the need for a metallic or plastic gas barrier eliminates the potential of a liner failure.

Embodiments of this disclosure can be used in gas storage applications in any range of pressures. The vessel may be a type III, IV, or V pressure vessel. The vessel may be used to store gases, liquids or powder. The vessel may include cooling channels, baffles, diaphragms, valves, regulators, or other fluid management devices designed and formed integral into the vessel. The shape of the vessel may be any predetermined shape suitable for the storage application. The vessel may be spherical or cylindrical in shape or non-spherical or non-cylindrical in shape. The vessel may have a geometry the same as, or substantially similar to, INFINITE COMPOSITES™ composite pressure vessels (Tulsa, Oklahoma).

Pressure vessels of this disclosure may be a composite overwrapped pressure vessel having a 3D printed mandrel that serves as its liner and as the permeation barrier or gas barrier. Or, the pressure vessel may be one that uses a removable mandrel process. The 3D printed mandrel still provides the shape of vessel, however it does not remain a part of the vessel, leaving only the composite material and resin to serve as the strength and permeation barrier.

Vessels of this disclosure may be used in applications such as, but not limited to lightweight mobile CNG refueling, launch system components, propulsion system components, nitrogen accumulator vessels, adsorbed natural gas storage vessels, where non-cylindrical composite pressure vessels are needed, high-pressure flow rate testing vessels, satellite propellant pressure vessels, cryogenic gas storage, satellite propulsion pressure vessels, medical oxygen, and pressurant vessels.

Embodiments of this disclosure include an additive manufacturing system for producing composite pressure vessels and structures using a combination of a dissolvable, or permanent, additively manufactured mandrel and composite overwrapped shell. The vessel may be produced using filament winding, automated fiber placement, continuous fiber printing, or a combination thereof. The vessel may also be produced by multiple axis robotic printer/filament winding arms oriented around a rotating substrate. Using the method of this disclosure, high performance composite pressure vessels and structures can be produced with enhanced performance, manufacturability, and scalability versus traditional methods.

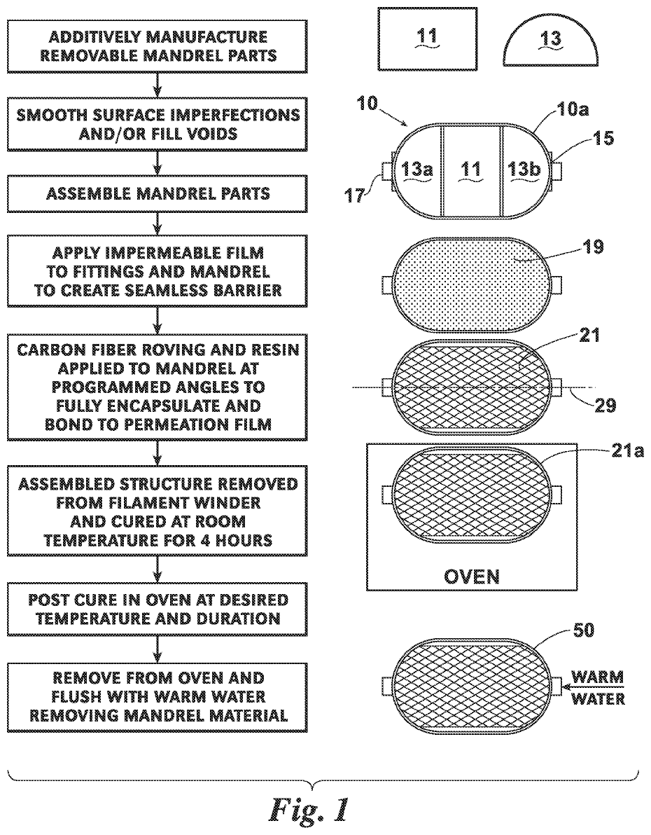

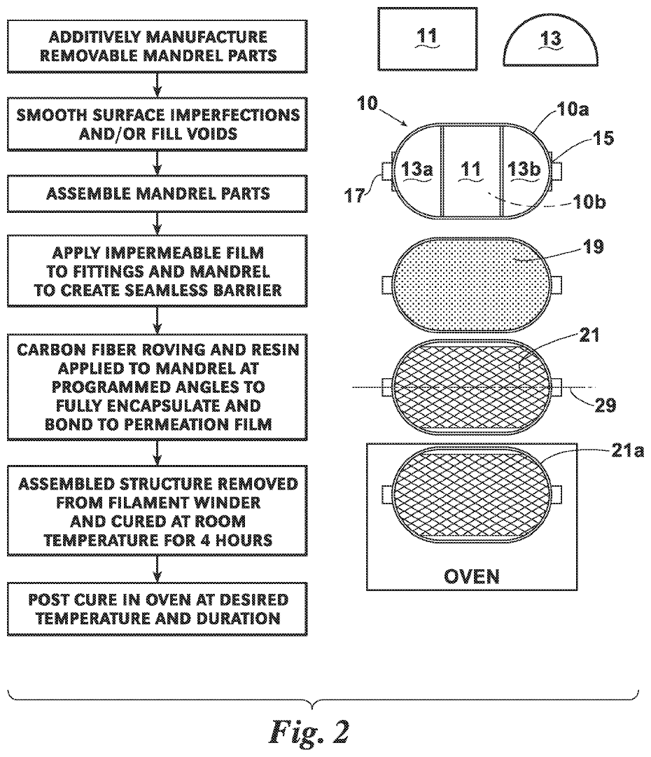

In embodiments, a mandrel is 3D-printed using a soluble material such as polyvinyl alcohol (“PVA”) and then overwrapped in a fibrous reinforcement impregnated with a polymeric resin to create a composite pressure vessel. The resin wrapped vessel is then cured. Once fully cured, the mandrel will be dissolved using water. See FIG. 1. In other embodiments, a non-soluble metallic or polymeric mandrel may be printed, the mandrel remaining trapped by the composite shell after the shell cures. See FIG. 2.

Regardless of whether the mandrel is soluble or remains a permanent component of the vessel, a composite pressure vessel of this disclosure can be produced with optimal performance characteristics and significantly reduced manufacturing time versus previous methods. The 3D printing process can be used for producing composite pressure vessels with complex geometries and integral features such as cooling channels, baffles, diaphragms, valves regulators, or other fluid management devices.

By way of example, a 3D-printed water soluble tool may use PVA that has been converted into a 3D printable filament. Any retail fused deposition modeling (“FDM”) 3D printer has the capability to print PVA filament. PVA is typically used in 3D printing as a supporting material for dual extruder printers. Here the purpose of the PVA print is to assist in the manufacturing of composite pressure vessels. With a low glass transition temperature almost all PVA filament prints at extrusion temperatures of 200-220° C. Bed or substrate temperature is at 50-60° C. This allows for proper bed adhesion and viscosity of the polymer. The PVA may undergo pyrolysis when experiencing higher temperatures for extended periods of time.

In printing the mandrel, a cad file is generated during an initial design and then loaded into a slicing software application that converts the cad file into a language used to control a CNC machine, called a “.gcode” file. Most parameters that dictate the manufacturing process and quality of the product are determined in this slicer file.

Examples of a composite pressure vessel of this disclosure include a 3D-printed mandrel and a shell wrapped about the mandrel, the mandrel being a soluble printed material, the shell including at least two layers of composite material, the mandrel being dissolved after the composite material of the shell cures, a storage space of the composite vessel being defined by the innermost face surface of the shell. The soluble printed material may be PVA or equivalents thereof.

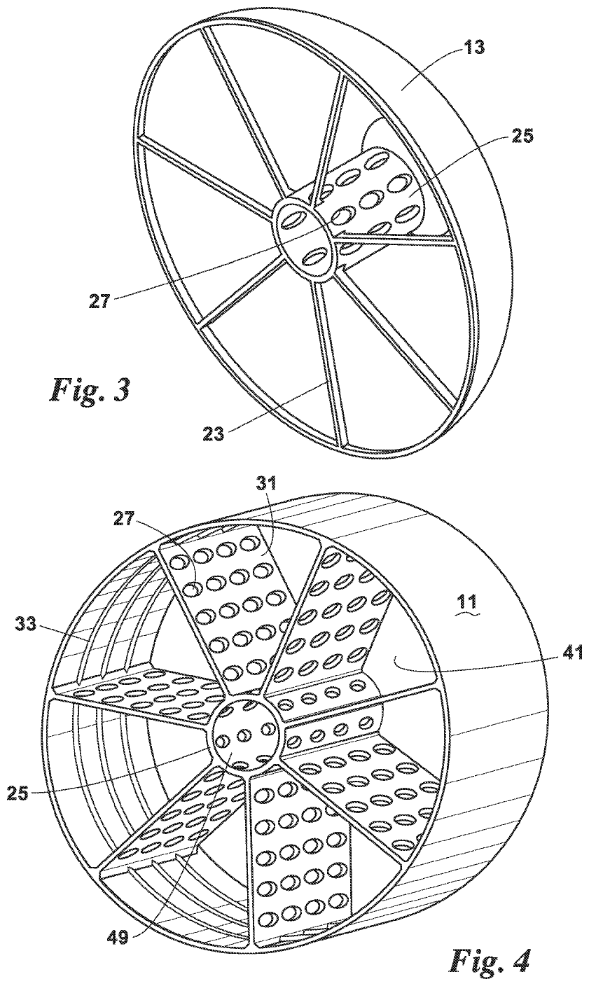

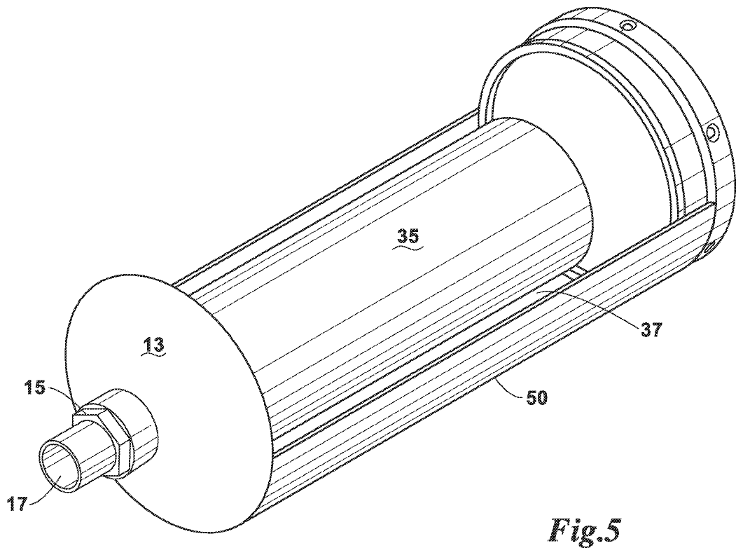

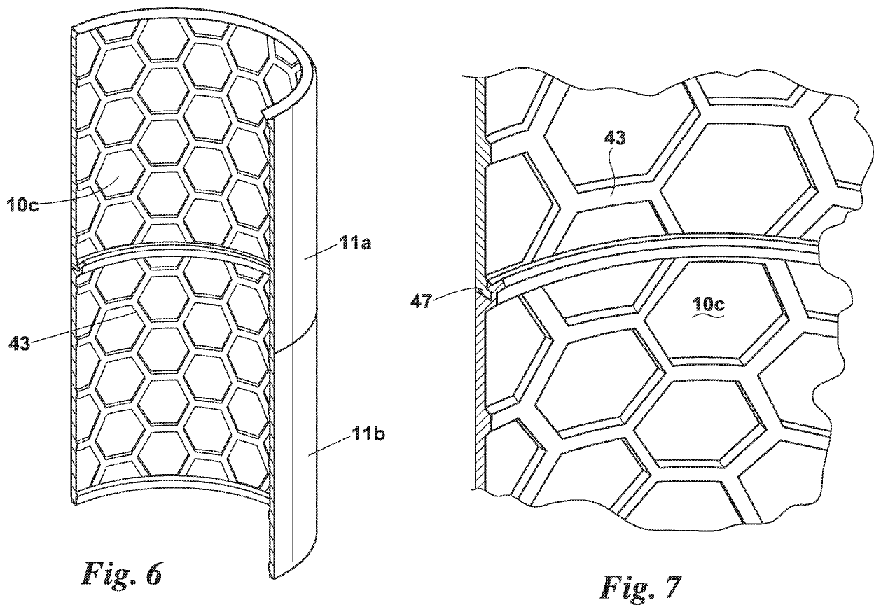

Another example of a composite pressure vessel of this disclosure include a 3D-printed mandrel and a shell wrapped about the mandrel, the mandrel being a non-soluble material, the shell including the at least two layers of composite material previously described. The mandrel may further contain at least one 3D-printed channel, baffle, diaphragm, valve, regulator, or enclosed volume, the channel, baffle, diaphragm, valve, regulator, or enclosed volume being printed as part of the mandrel. See e.g. FIGS. 3-5. The storage capacity of the composite vessel is defined by the physical mandrel size.

1. A computer readable medium storing computer readable instructions which, when acted upon by a 3D printer, cause the 3D printer to print a mandrel (10) of a composite pressure vessel, the mandrel having a predetermined size, shape, and internal volume (10c) and including at least one end (13) having an opening (17) to the internal volume.

2. The computer readable instructions of claim 1, further comprising, when acted upon by the 3D printer, cause the 3D printer to print a fluid management device integral to and contained by the mandrel.

3. The fluid management device of claim 2, wherein the fluid management device is a baffle (31).

4. The baffle of claim 3, wherein the baffle is arranged coaxial a longitudinal centerline (29) of the mandrel.

5. The baffle of claim 4, wherein the baffle extends in a radial direction relative to the longitudinal centerline of the mandrel.

6. The baffle of claim 3, wherein the baffle includes a plurality of through holes (27).

7. The fluid management device of claim 2, wherein the fluid management device is a cylinder (25) arranged coaxial a longitudinal centerline of the mandrel, the cylinder including a plurality of though holes (27).

8. The fluid management device of claim 2, wherein the fluid management device divides the internal volume into at least two chambers (41).

9. The at least two chambers of claim 8, wherein the at least two chambers are in fluid communication with one another.

10. The fluid management device of claim 2, wherein the fluid management device is a channel (49).

11. The fluid management device of claim 2, wherein the fluid management device is a diaphragm.

12. The computer readable instructions of claim 1, further comprising, when acted upon by the 3D printer, cause the 3D printer to print a valve contained in part by the opening.

13. The mandrel of claim 1, wherein the mandrel further includes a boss (15), the opening defined by the boss.

14. The computer readable instructions of claim 1, wherein the computer readable instructions are in a slicing file.

15. The mandrel of claim 1, further comprising, a first end section (13a), a second end section (13b), and a middle section (11).

16. The mandrel of claim 16, wherein the first and second end sections are domed ends and the middle section is cylindrical.

17. The mandrel of claim 1, further comprising, an inside surface (10c) of the mandrel including an iso-grid (43).

18. A digital representation of the mandrel of any of the claims 1 to 17.

19. A method for producing a composite pressure vessel, the method comprising:
3D printing a mandrel, the mandrel having a predetermined size, shape, and internal volume, the mandrel including at least one end having an opening to the internal volume;
after the 3D printing, smoothing surface imperfections, filling surface voids, or smoothing surface imperfections and filling surface voids;
after the smoothing or filing or smoothing and filling, assembling at least one fitting to the mandrel;
after the assembling, applying an impermeable film to the at least one fitting and the mandrel;
after the applying, encapsulating the impermeable film by applying at preprogramed angles a carbon fiber roving and resin to the mandrel; and
after the encapsulating, curing the composite pressure vessel.

20. The method of claim 19, wherein the mandrel comprises at least two 3D printed parts, the assembling including the at least two 3D printed parts.

21. The method of claim 18, wherein the mandrel is soluble, the method further comprising, after the curing, flushing the pressure vessel with water to dissolve the mandrel.
